(19) United States
(12) Patent Application Publication
(10) Pub. No.: US 2025/0132362 A1
(43) Pub. Date: Apr. 24, 2025

(54) METHOD FOR DRYING A FUEL CELL, AND FUEL CELL SYSTEM

(71) Applicant: Robert Bosch GmbH, Stuttgart (DE)

(72) Inventors: Jonas Breitinger, Stuttgart (DE); Helerson Kemmer, Vaihingen (DE); Mark Hellmann, Korntal (DE)

(21) Appl. No.: 18/684,948

(22) PCT Filed: Aug. 19, 2022
(86) PCT No.: PCT/EP2022/073201

§ 371 Date: Feb. 20, 2024

(30) Foreign Application Priority Data
Sep. 14, 2021 (DE) 10 2021 210 110.0

(51) Int. Cl. H01M 8/04858; H01M 8/04119; H01M 8/04223; H01M 8/04492; H01M 8/04828; H01M 8/10

(52) U.S. Cl. CPC H01M 8/0491; H01M 8/04179; H01M 8/04253; H01M 8/04507; H01M 8/04843; H01M 8/0485; H01M 2008/1095

(57) ABSTRACT

A method for drying a fuel cell (10) for generating electrical energy for a consumer (20), in particular for a vehicle (20), in which an anode gas having a first reactant is supplied to an anode (200), and a cathode gas having a second reactant is supplied to a cathode (100), and the reactants are converted into electricity along a flow path (300) in the fuel cell (10) by means of an electrochemical reaction, the method having the following steps:
a) flushing (2) the cathode (100) with the cathode gas;
b) operating (4) the fuel cell (10) with so little cathode gas that the second reactant is substantially consumed along the flow path (300) by the electrochemical reaction for conversion to electricity, an electric current density of the fuel cell (10) being less than 20% of a maximum achievable electric current density of the fuel cell (10).

### BACKGROUND

The invention relates to a method for drying a fuel cell, in which an anode gas with a first reactant is supplied to an anode and a cathode gas with a second reactant is supplied to a cathode and converted into electricity by an electrochemical reaction along a flow path in the fuel cell. The invention also relates to a fuel cell system.

Fuel cells are regarded as the mobility concept of the future. Hydrogen-based fuel cells in particular are especially climate-friendly and practical, as they only emit water as exhaust gas and can also be refueled in a short time.

At relatively low temperatures below freezing point, the problem has arisen that local icing can occur in the fuel cell, which could prevent the fuel cell system from starting. At the very least, however, ice formation can hinder or slow down the reaction for electricity generation. At the same time, usage requirements result in the desire for a fast, safe start, even at temperatures below freezing.

As a rule, ice formation can be prevented by ensuring that the fuel cell system is dry. However, if the fuel cell system contains water, it must be dried at low temperatures. As a rule, this drying takes place on the cathode side by conveying air, which removes water from the fuel cell in gaseous and liquid form.

In order to avoid excessive cell voltages, which contribute to ageing of the fuel cells, electricity can be drawn during drying, which can be used, for example, to operate the pumps.

When drying the fuel cell, the greatest drying is usually achieved at the input region of the cathode, where the air flows in first. The result is an inhomogeneous humidity distribution within the fuel cell. This can result in impermissibly dry regions of the cells at the cathode input. A region in which the membrane becomes so dry locally that remoistening is significantly impeded by a greatly reduced diffusion coefficient is not permissible. At the same time, excessive drying puts a strain on the membrane and thus shortens its service life.

### SUMMARY

The invention provides a method and a fuel cell system having the features of the disclosure. Further features and details of the invention will emerge from the respective dependent claims, the description, and the drawings. In this context, features and details described in connection with the method according to the invention clearly also apply in connection with the fuel cell system according to the invention, and respectively vice versa, so that with respect to the disclosure, mutual reference to the individual aspects of the invention is or can always be made.

Provided according to a first aspect of the invention is a method for drying a fuel cell for generating electrical energy for a consumer, in particular for a vehicle, in which an anode gas having a first reactant is supplied to an anode, and a cathode gas having a second reactant is supplied to a cathode, and the reactants are converted into electricity along a flow path in the fuel cell by means of an electrochemical reaction, the method having the following steps:
flushing the cathode with the cathode gas;
operating the fuel cell with so little cathode gas that the second reactant is substantially consumed along the flow path (300) by the electrochemical reaction for conversion to electricity, an electric current density of the fuel cell (10) being less than 20% of a maximum achievable electric current density of the fuel cell (10).

The method steps according to the invention can be performed in the specified order, or in an amended order. The methods steps according to the invention can be performed simultaneously, at least in part concurrently, and/or sequentially.

The invention recognizes that with a regular drying strategy according to the prior art, the drying of the fuel cell is inhomogeneous and, in particular, unacceptably dry regions occur at the cathode input. This drying according to the prior art is also performed in a first step according to the present invention. However, the second step, in which so little cathode gas is supplied to the cathode that the second reactant along the flow path is essentially consumed by the electrochemical reaction for conversion to electricity, means that the chemical reaction of the reactants in the fuel cell, in which water is produced, only takes place in the input region of the cathode, or that water is preferably produced at the input region of the cathode. In the remaining region of the fuel cell, on the other hand, it is operated according to the invention in oxygen-depleted mode, so that no water can be produced there by the chemical reaction of the fuel cell. This inhomogeneous reaction, in which water is preferentially produced in the input region of the cathode, compensates for the drying process, which is also inhomogeneous and mainly dries the cathode input region. In order to shift the water production to the cathode input, the fuel cell is operated at an electrical current density of less than 20%, in particular less than 15% or less than 10% of the maximum achievable current density of the fuel cell (nominal current density). The maximum achievable current density is generally reached at the full load point of the fuel cell. The reduced current density ensures that the active area of the input region is sufficient to essentially consume the oxygen without exceeding the local limiting current density. A reduction to 15% or 10% offers the additional advantage that exceeding the local limiting current density is prevented particularly reliably.

A fuel cell within the meaning of the invention is a galvanic cell which converts the chemical reaction energy of a fuel and an oxidizing agent into electrical energy. The fuel cell can be designed such that it is suitable for stationary and/or mobile applications. In particular, it can be provided such that the fuel cell is the main energy supplier for a vehicle. It is also conceivable that the fuel cell within the meaning of the invention is used for an auxiliary drive of a vehicle.

The fuel cell can be part of the fuel cell system, in which one or more fuel cells, which have one or more stacks, are provided and which can also be equipped with functional systems. The functional systems include, e.g., anode and cathode gas systems which are, i.e., also designed to condition the anode or cathode gas for the fuel cell by, e.g., adjusting the pressure, setting the temperature, or filtering unwanted substances. The fuel cell system can further comprise a control unit which is suitable for controlling the components of the fuel cell system.

It can be provided that the anode gas contains hydrogen. It can also be provided that the first reactant comprises hydrogen. The cathode gas can be air, especially dehumidified air. It can be provided that the second reactant is oxygen. The fuel cell can be designed as a polymer electrolyte fuel cell. A flow path in the sense of the invention is the path that the anode gas or cathode gas travels from the respective source to an exhaust air within a fuel cell system or in a fuel cell. Within the fuel cell, the flow path of the anode gas is formed from an anode input of the anode to the anode output of the anode. Accordingly, the flow path of the cathode gas within the fuel cell is from a cathode input of the cathode to a cathode output of the cathode. It is possible that the electrodes comprise flow structures which, in combination with the membranes, form flow channels that define the flow path of the gases.

It can be provided that a cathode system directs ambient air, in particular treated ambient air, to the cathode input when flushing the cathode with the cathode gas, whereby the cathode gas absorbs water from the fuel cell, and then directs it from the cathode output of the cathode to an exhaust air, so that water is discharged from the fuel cell.

According to step b) of the teaching of the present invention, the fuel cell is operated by depleting the second reactant, in particular by oxygen depletion. The second reactant along a flow path from the cathode input of the cathode to the cathode output of the cathode can be used up to over 90%, in particular over 95% or over 99%. It is also possible that the second reactant be completely consumed within the flow path from the cathode input to the cathode output. It can be provided that the second reactant is consumed along the flow path from the cathode input to the cathode output within the first half of the flow path, in particular within the first third or within the first tenth. It can also be provided that the distance along the flow path from the cathode input to the cathode output, in which the second reactant is consumed, essentially corresponds to the region which was dried more by the cathode in the previous rinsing step than the mean value in the drying within the cathode.

Within the scope of the invention, it is also conceivable that steps a) and b) are performed at least repeatedly or alternately.

In other words, steps a) and b) can be performed several times and/or alternately. The advantage of this is that, on the one hand, the fuel cell can be dried more thoroughly by repeating the process and, on the other hand, the alternating performance of the steps simultaneously homogenizes the drying process.

Within the scope of the invention, it is also conceivable that step b) is performed until a state of inhomogeneity of a humidity distribution in the cathode is equalized.

In other words, step b) can be performed until the humidity distribution within the cathode is essentially homogenized. It can be provided that an inhomogeneity limit value is predetermined. This can be measured by, e.g., the cathode activity. For example, it can be provided that the inhomogeneity limit value is reached when the cathode activity over the flow path within the cathode is at no point less than the impermissible range at which the membrane becomes so dry locally that remoistening is significantly reduced by a greatly reduced diffusion coefficient. It can also be provided that the inhomogeneity limit value is reached when the cathode activity is less than 0.1, in particular less than 0.2 or less than 0.5, above the flow path within the cathode.

The measures specified hereinabove have the advantage that there are no impermissibly dry regions at the input of the cathode, so a cold start is reliably possible, and the service life of the membrane or the fuel cell can be extended.

It is further conceivable in a method according to the invention that the method further comprises one of the following steps:
detection of a dry state in which a humidity distribution in the cathode has reached a predetermined inhomogeneity limit value, and/or a homogeneity state in which a humidity distribution in the cathode has reached a predetermined homogeneity limit value,
detection of a target state in which the humidity distribution in the cathode has reached a predetermined homogeneity limit value, and a humidity in the cathode has reached a predetermined humidity limit value, monitoring of the humidity in the cathode.

In other words, the method according to the invention can comprise at least two further steps. On the one hand, the humidity distribution within the cathode can be particularly inhomogeneous, which corresponds to a dry state. On the other hand, the humidity distribution within the cathode can be particularly homogeneous, which corresponds to a state of homogeneity. In addition, a further state, which is referred to as a target state, can also be recognized, in which the humidity within the cathode is both homogeneously distributed and below a certain threshold value, so that the cathode is homogeneously dry enough in the target state in order to start the fuel cell.

The detection of the respective states offers the advantage that the drying of the fuel cell can be controlled particularly precisely. As a result, the fuel cell is effectively prevented from having impermissibly dry regions, which reduces the service life of the fuel cell. It can be provided that a sensor system is provided for detecting the states, which has at least one sensor that is designed in particular for measuring the humidity and/or the humidity distribution within the cathode and/or the fuel cell. This offers the advantage of being able to reliably determine the condition of the fuel cell using currently measured and therefore particularly precise data, so that homogeneous drying of the fuel cell is ensured. Alternatively or additionally, it can also be possible to calculate the state of the fuel cell based on a model. This offers the advantage that such a fuel cell system does not require cost-intensive sensors, which also take up installation space.

Furthermore, in a method according to the invention, it is conceivable that at least one of the following steps is performed:
if a dry state is detected, the method is at least continued or started at step b),
if a homogeneity state is detected, the method is at least continued or started at step a),
if a target state is detected, the method is at least continued or started at step e)

In other words, depending on the detection of a fuel cell condition, either further flushing, operation in oxygen depletion mode or the drying process is terminated altogether. The advantage thereby is that the fuel cell can be dried particularly reliably and homogeneously.

It is also conceivable in a method according to the invention that at least a dry state, a homogeneity state or a target state of the cathode is determined by one of the following methods:
measuring an output humidity at least at an exhaust air, an output of the cathode, or at an output of an anode,
measuring an electrochemical impedance spectrum of the fuel cell, in particular the resistance of a membrane of the fuel cell,
measuring a stack voltage of the fuel cell,
measuring a current density distribution of the fuel cell,
estimation, in particular of a humidity and/or a humidity distribution in the fuel cell, by means of an algorithm, in particular a machine-learned algorithm.

In other words, the state of the fuel cell or cathode can be determined either by measurement or by calculation. The advantage of the measurement-based determination of the cathode states is that they are particularly precise and can determine the state of the cathode particularly reliably. An estimation or calculation-based determination of the cathode offers the advantage that this can be done particularly quickly and easily, which can save both installation space and costs. It can be provided that a fuel cell system comprises a sensor system which has at least one sensor. Such a sensor can, e.g., be a humidity sensor, a sensor for measuring an electrical-chemical impedance spectrum, a voltage sensor, and/or a current density sensor. The condition of the cathode or the fuel cell system can be determined with particular certainty using the corresponding sensors. A control unit can be provided which evaluates the data from the sensor system and controls the fuel cell system according to the determined state. It can be provided that the state of the fuel cell is estimated by estimating a humidity and/or a humidity distribution in the fuel cell. Furthermore, it can also be provided that, in particular, one of the measured values specified hereinabove is estimated by the algorithm. This offers the advantage that the values determined by the algorithm can be compared with real values. In particular, if the measurement is performed in addition to the estimation during the method, then the plausibility of the values can be determined.

The algorithm for estimating the state of the cathode or the fuel cell system can be based on empirical data from the same or other fuel cells. Furthermore, the algorithm can also be designed to evaluate measured values of the fuel cell during operation and output the status. It can also be provided that a fuel cell system comprises a computing unit on which the algorithm is performed. The computing unit can be designed as part of the control unit. Such a design offers the advantage that drying can be performed particularly cost-effectively and precisely at the same time.

Preferably, in a method according to the invention, it can be provided that a dry state is dependent on a standardized water loading for a membrane of the fuel cell, whereby the dry state is in particular reached when the standardized water loading is less than the critical water loading parameter, the critical water loading parameter in particular being 6, 4, or 2.5.

In other words, a dry state is reached in particular when a certain number of water molecules are present per phosphate group of a polymer electrolyte membrane fuel cell. The water loading is a particularly suitable parameter for determining the dry state of the cathode, as the impermissible range in which the membrane becomes so locally dry that remoistening significantly reduces the diffusion coefficient is dependent on the water loading. A range in which the water loading is below 2 and/or in diffusion coefficient in cm²/s<0.4, in particular below 0.3 or 0.2, can be regarded as impermissible. The advantage of such a delimitation of the dry state is that an impermissible dryness of the cathode or the fuel cell can be reliably prevented.

Preferably, in a method according to the invention, it can be provided that, when measuring an electrochemical impedance spectrum of the resistance of the fuel cell, in particular the resistance of a membrane of the fuel cell, a high-frequency resistance is determined, the high-frequency resistance being the resistance above a cut-off frequency, in particular at a cut-off frequency of 1 kHz.

In other words, the electromagnetic impedance spectrum can be recorded at a high frequency so that the ohmic resistance of the membrane can be separated from the other loss mechanisms in the fuel cell. If the measured resistance increases during the drying of the fuel cell, this corresponds to a strong drying of the membrane. The use of a high-frequency electrochemical impedance spectrum therefore offers the advantage that drying of the membrane can be reliably detected and drying into the impermissible range can be reliably avoided. If a cut-off frequency, in particular >1 kHz, is used, then the drying state of the membrane can in this case be determined with particular certainty.

Furthermore, in a method according to the invention, it can advantageously be provided that the energy generated in the fuel cell when performing the method for drying a fuel cell is at least used for performing the method for drying a fuel cell.

In other words, energy, which is already provided in the form of discharged current to avoid voltage peaks within the fuel cell, can be used to operate the components that perform the method according to the invention. This offers the advantage that the drying method for the fuel cell can be performed in a particularly energy-saving and therefore cost-reducing manner. In particular, the energy can be used to operate a fluid energy machine in order to flush the cathode with cathode gas. This also offers the advantage that the fuel cell can be dried in a particularly energy-saving manner.

Provided according to a further aspect of the invention is a fuel cell system having a control unit, which is designed to perform a method for drying a fuel cell.

According to this further aspect of the invention, a fuel cell system can then be provided, which comprises components which are designed to perform the method for drying the fuel cell according to the invention. The control unit can be designed to evaluate data from a sensor system that performs measurements on the fuel cell or fuel system. The control unit can comprise a computing unit for this purpose. The control and/or computing unit can also be designed to determine a state of the fuel cell or the fuel cell system based on an algorithm, whereby the algorithm can also be a machine-learning algorithm.

Therefore, a fuel cell system according to the invention has the same advantages as those already described in detail with reference to a method according to the invention, a flushing method according to the invention, an operation method according to the invention, a detection method according to the invention, and/or a monitoring method according to the invention.

Further advantages, features, and details of the invention will emerge from the following description, in which exemplary embodiments of the invention are described in detail with reference to the drawings. In this context, the features specified in the claims and in the description can each be essential to the invention, individually or in any combination. Shown schematically are:

### BRIEF DESCRIPTION OF THE DRAWINGS

FIG. 1 a schematic representation of a typical curve of the diffusion coefficient in cm²/s as a function of the water loading

FIG. 2 a diagram of the cathode activity as a function of a normalized run length of the cathode gas in the cathode,

FIG. 3 a flow chart according to an exemplary embodiment of the drying method,

FIG. 4 a representation of the fuel cell

FIG. 5 a representation of a vehicle which has a fuel cell according to the invention with a control unit.

### DETAILED DESCRIPTION

In the following description of several exemplary embodiments of the invention, identical reference signs are used for identical technical features, even in different exemplary embodiments.

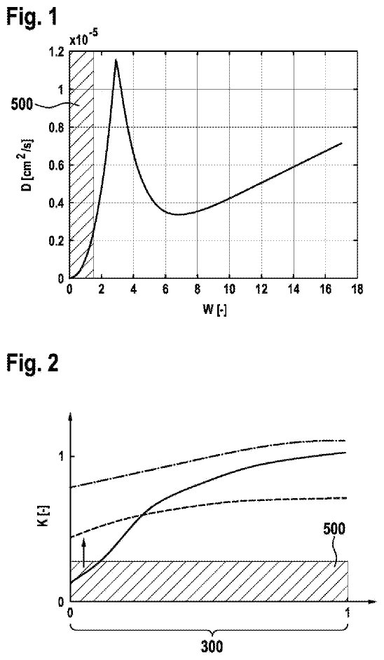

FIG. 1 shows a diffusion coefficient for water as a function of the water loading on the membrane of a fuel cell. A high water loading, as shown in the diagram on the right, corresponds in this case to a state of the fuel cell in which there is a risk of local icing. Flushing the fuel cell or cathode can dry the membrane, which reduces the water loading on the membrane. As seen in FIG. 1, the diffusion coefficient in cm²/s for water initially decreases continuously in this case. After a maximum of the diffusion coefficient at a water loading of approximately 3 is exceeded, the diffusion coefficient drops sharply to 0 cm²/s. An impermissible range 500 is reached in this case, in which the diffusion coefficient is greatly reduced and the membrane becomes so dry locally that remoistening is prevented. Such severe drying of the membrane also shortens the service life of the fuel cell.

FIG. 2 illustrates how the method according to the invention can be used to enable drying of the fuel cell 10 without causing excessive drying in the region of the cathode input 110. A normalized run length 300 is shown on the x-axis, which corresponds to the flow path of the cathode 100 from the cathode input 110 to the cathode output 120. The cathode activity shown on the y-axis is significantly influenced by the humidity of the membrane 300. A low cathode activity corresponds to a low humidity of the membrane 300. In an ideal state, the cathode activity over the entire flow path would correspond to 300 one. In real operation of a fuel cell, a cathode activity is usually achieved which corresponds approximately to the dotted line in FIG. 2. Drying the fuel cell 10 according to the prior art leads to the situation shown in the continuous line. The cathode activity at a cathode input 110 of the cathode 100 is reduced by excessive drying of the membrane 300 to such an extent that an impermissible range 500 is reached. However, at a cathode output 120 of the cathode 100, the cathode activity is still at an acceptable level and the drying of the membrane 300 is satisfactory. Using the method according to the invention, the membrane 300 can be moistened with water at the cathode input 110, so that a cathode activity as shown in the dashed line in FIG. 2 can be achieved.

By performing the method alternately and/or repeatedly, it can be achieved that the membrane 300 is dried particularly strongly and homogeneously.

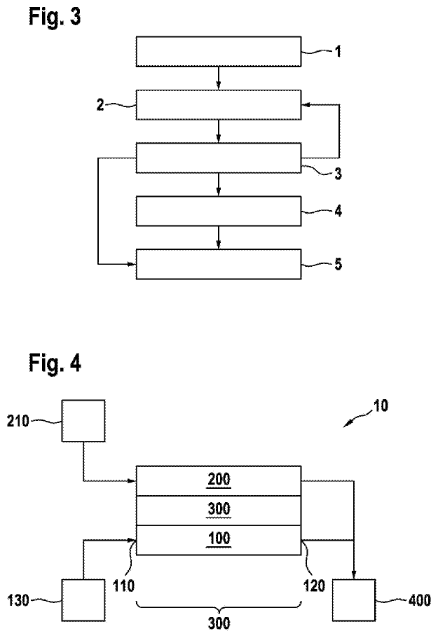

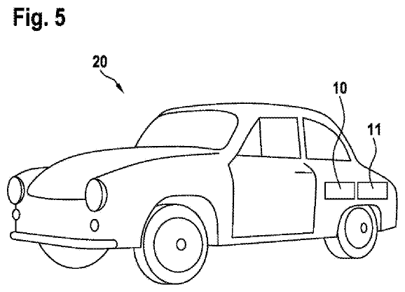

Finally, FIG. 3 shows a flow chart of an exemplary embodiment of the method for drying a fuel cell 10. First, the humidity of the cathode 100 is monitored 1. If it is determined that local icing could occur in the fuel cell 10, or if drying is recognized as necessary, the cathode 100 is flushed with cathode gas 2. In a detection step 3, a dry state in which a humidity distribution in the cathode 100 reaches a predetermined inhomogeneity value and/or a homogeneity state in which the humidity distribution in the cathode 100 has reached a predetermined homogeneity value is detected. If a dry state is detected, the method is continued when operating 4 the fuel cell 10 with so little cathode gas that the second reactant along the flow path 300 is essentially consumed by the electrochemical reaction for conversion to electricity. If, on the other hand, a homogeneous state is detected, the method is continued at step a) flushing 2 of the cathode 100 with the cathode gas. If the humidity distribution in the cathode 100 has reached a predetermined homogeneity value and the humidity in the cathode 100 has reached a predetermined humidity limit value, a target state 5 has been detected. In this case, it can be provided that the method transitions back to monitoring 1 the humidity of the cathode 100.

Finally, a fuel cell 10 is shown schematically in FIG. 4. The latter comprises a cathode 100 with a cathode input 110 and a cathode output 120. Cathode gas is in this case supplied from a cathode gas unit 130 at the cathode input 110 of the cathode 100. The cathode gas is in this case conducted from the cathode input 110 to the cathode gas output 120 via a flow path 300 within the cathode 100.

Also provided in the fuel cell 10 is an anode 200, which is supplied with anode gas by an anode system 210. An exhaust air 400 is provided downstream of the cathode output 120, where the anode gas and cathode gas mix with each other. A membrane 300 is also provided between the cathode 100 and the anode 200, which separates the electrodes 100 and 200 from each other.

Finally, in FIG. 4, a vehicle 20 is provided which has a fuel cell 10 with a control unit 11, whereby the control unit 11 can be illustrated for performing a method for drying a fuel cell 10 according to the invention.

The explanation hereinabove of the embodiments describes the present invention solely within the scope of examples. Of course, individual features of the embodiments can be freely combined with one another, if technically feasible, without leaving the scope of the present invention.

1. A method for drying a fuel cell (10) for generating electrical energy for a consumer (20), in which an anode gas having a first reactant is supplied to an anode (200), and a cathode gas having a second reactant is supplied to a cathode (100), and the reactants are converted into electricity along a flow path (300) in the fuel cell (10) by means of an electrochemical reaction, the method having the following steps:
a) flushing (2) the cathode (100) with the cathode gas,
b) operating (4) the fuel cell (10) with an amount of cathode gas that the second reactant is substantially consumed along the flow path (300) by the electrochemical reaction for conversion to electricity, wherein an electric current density of the fuel cell (10) is less than 20% of a maximum achievable electric current density of the fuel cell (10).

2. The method for drying a fuel cell (10) according to claim 1,
wherein
steps a) and b) are performed at least repeatedly or alternately.

3. The method for drying a fuel cell (10) according to claim 1,
wherein
step b) is performed until an inhomogeneity state of a humidity distribution in the cathode (100) is compensated for.

4. The method for drying a fuel cell (10) according to claim 1, one of the preceding claims,
wherein
the method further comprises one of the following steps:
c) detection (3) of a dry state in which a humidity distribution in the cathode (100) has reached a predetermined inhomogeneity limit value and/or
of a homogeneity state in which a humidity distribution in the cathode (100) has reached a predetermined homogeneity limit value,
d) detection (5) of a target state in which the humidity distribution in the cathode (100) has reached a predetermined homogeneity limit value, and a humidity in the cathode (100) has reached a predetermined humidity limit value, or
e) monitoring (1) of the humidity in the cathode (100).

5. The method for drying a fuel cell (10) according to claim 1,
wherein
at least one of the following steps is performed:
if a dry state is detected, the method is at least continued or started at step b),
if a homogeneity state is detected, the method is at least continued or started at step a), or
if a target state is detected, the method is at least continued or started at step e).

6. The method for drying a fuel cell (10) according to claim 1,
wherein
at least a dry state, a homogeneity state or a target state of the cathode (100) is determined by one of the following methods:
measuring an output humidity at least at an exhaust air (400), an output (120) of the cathode (100) or at an output (220) of an anode (200),
measuring an electrochemical impedance spectrum of the fuel cell (10),
measuring a stack voltage of the fuel cell (10),
measuring a current density distribution of the fuel cell (10), or
estimating a humidity and/or a humidity distribution in the fuel cell (10), by means of an algorithm, in particular a machine-learned algorithm.

7. The method for drying a fuel cell (10) according to claim 1,
wherein
a dry state is dependent on a standardized water loading for a membrane of the fuel cell (10), wherein the dry state is in particular reached when the standardized water loading is less than a critical water loading parameter, wherein the critical water loading parameter is in particular 6, 4, or 2.5.

8. The method for drying a fuel cell (10) according to claim 1,
wherein
when measuring an electrochemical impedance spectrum of the resistance of the fuel cell (10), in particular the resistance of a membrane (300) of the fuel cell (10), a high-frequency resistance is determined, wherein the high-frequency resistance is the resistance above a cut-off frequency.

9. (canceled)

10. A fuel cell system comprising at least one fuel cell (10) and a control unit (11), wherein the control unit (11) is designed to perform a method for drying a fuel cell (10) according to claim 1.
